(19) United States
(12) Patent Application Publication
(10) Pub. No.: US 2026/0042509 A1
(43) Pub. Date: Feb. 12, 2026

(54) ANCHORING SYSTEM AND METHOD FOR INSTALLING AND UNINSTALLING THE ANCHORING SYSTEM

(71) Applicant: GAZELLE WIND POWER LIMITED, DUBLIN (IE)

(72) Inventor: Antonio Luis GARCÍA FERRÁNDEZ, POZUELO DE ALARCÓN (ES)

(21) Appl. No.: 19/141,243

(22) PCT Filed: Dec. 20, 2023
(86) PCT No.: PCT/IB2023/063018

§ 371 Date: Jun. 19, 2025

(30) Foreign Application Priority Data
Dec. 21, 2022 (ES) P202231091

(51) Int. Cl. B63B 21/29; B63B 21/50; B63B 22/02; B63B 35/44; F03D 13/25

(52) U.S. Cl. CPC B63B 21/29; B63B 21/502; B63B 22/02; B63B 2021/505; B63B 2022/028; B63B 2035/446; F03D 13/256; F05B 2230/60; F05B 2230/70

(57) ABSTRACT

Anchoring system having a floating platform from which first anchoring lines emerge, an anchoring block with at least three non-aligned anchoring points, a central float swinging arms being joined by a joint to the block, the joint located in an intermediate area so that each arm has an internal section and an external section, the internal section located between the intermediate area and an inner free end, and the outer section located between the intermediate area and an outer free end, the inner end closer to the central float than the outer end, so that first anchoring lines leaving the floating platform are joined to the outer free ends. The system has second anchoring lines between the central float and the inner end portions containing the inner free ends of the inner sections of the arms. Also a method of install and uninstalling such a system.

### CROSS-REFERENCE TO RELATED APPLICATIONS

This application is a national phase of International Patent Application No. PCT/IB2023063018, filed on Dec. 20, 2023, which claims the benefit of Spanish Patent Application No. P202231091, filed on Dec. 21, 2022, the entire disclosures of which are incorporated herein by way of reference.

### FIELD OF THE INVENTION

The present invention relates to an anchoring system especially suitable for floating platforms that serve as a base for wind turbines located offshore. It also relates to a procedure for installing said anchoring system and a procedure for uninstalling said anchoring system.

### BACKGROUND OF THE INVENTION

Floating platforms, especially those dedicated to supporting wind turbines for the generation of electricity from offshore wind energy, need anchoring systems that keep them in position and contribute to their stability.

In the prior art, platforms of the type called TLP (Tension Leg Platform) are known. These platforms comprise three or more anchoring lines (usually chains or cables that link the platform with piles anchored to the seabed). The anchoring lines of the TLP platforms are designed to be arranged in tension, joining the platform vertically with each of the piles anchored to the seabed. TLP platforms comprise a set of floats designed to produce an excess of buoyancy of the platform (taking into account the weight of the structure that is set on the platform). This excess buoyancy guarantees a high level of tension in the cables, which in turn guarantees that they are always arranged in an upright position. In this way, pitch and roll movements of the platform and the structure that are set upon the platform are avoided.

EP 2743170 A1 discloses an example of TLP platform.

A drawback of TLP platforms is that the high tension of the cables necessary to keep them in a vertical position and thus avoid pitching and/or roll movements also produces a blockage of the displacements in the vertical direction of the platform. Thus, when the tide rises, the platform cannot move upwards (because the anchoring lines have reduced or no extensibility) and, therefore, the tension in the anchoring lines increases considerably. This causes a high risk of breakage of the anchoring lines and requires the availability of high section anchoring lines or an increase in the number of anchoring lines. Additionally, in TLP platforms, in situations of very low tide, the low platform and the anchoring lines can also become very loose, increasing the risk of the platform moving both vertically and laterally in an uncontrolled manner, and also increasing the risk of pitch and/or roll movements (due to the thrust of the wind and/or waves on the platform and the structure that is set upon it) that can cause the platform to tip over.

To avoid the aforementioned drawbacks, another type of floating platforms are known where the anchoring lines are connected with a counterweight through pulleys located on the platform. This type of platform allows the vertical and lateral displacement of the platform in the face of tides, waves and wind, thus making it unnecessary to have a large number of anchoring lines or anchoring lines with an elevated section. Document ES 2629867 A2 describes a platform of this type.

A drawback of platforms fitted with counterweight and pulleys such as those described above is that the anchoring lines (especially when it comes to anchoring cables) experience bending fatigue over time since, as they pass through the pulleys, the anchoring lines in tension bend and wear. This can cause, over time, the breakage of the anchoring lines.

### SUMMARY OF THE INVENTION

An object of the present invention is therefore to provide an anchoring system that allows the drawbacks of the prior art to be remedied.

The invention provides an anchoring system that comprises:
a floating platform from which a plurality of first anchoring lines emerge,
at least one anchorage block, with at least three non-aligned anchor points,
a central float,
a plurality of swinging arms, each swinging arm being joined by an articulated joint to an anchoring block, said articulated joint being located in an intermediate zone of the swinging arm so that each swinging arm comprises an inner section and an outer section joined in the intermediate zone of the swinging arm corresponding to the articulated joint, the inner section being located between the intermediate zone of the swinging arm and an inner free end and the outer section being located between the intermediate zone of the swinging arm and an outer free end, the inner free end being closer to the central float than the outer free end, so that the first anchoring lines leaving the floating platform are joined to the outer end part containing the outer free end of the outer sections of the swinging arms, and
second anchoring lines between the central float and the inner end parts containing the inner free ends of the inner sections of the swinging arms.

The invention also provides a procedure for installing the anchoring system comprising the following steps:
assembly of at least one anchoring block with the swinging arms, each swinging arm being joined by means of an articulated connection with a support to an anchoring block; fixing of the first anchoring lines to the outer end part that contains the outer free end of the external sections of the swinging arms; and joining the free end of the first anchoring lines with a respective buoy,
fixing the second anchoring lines to the central float,
placement of at least one anchoring block on the seabed, so that the first anchoring lines are deployed vertically hanging from the corresponding buoys,
location of the floating platform with the wind turbine tower on the sea surface, vertically with respect to the position of at least one anchoring block,
the buoys are released from the end of the first anchoring lines and said ends of the first anchoring lines are attached to the floating platform,
the central float is placed next to the floating platform and the central float is hooked to a winch inside the wind turbine tower whose cables runs through a hole that runs through the center of the floating platform,
the central float is flooded, so that it descends and hangs from the winch, with the second anchoring lines hanging from the bottom of the central float,
joining the second anchoring lines with the inner end parts containing the inner free ends of the inner sections of the swinging arms,
the central float is emptied, the winch is disengaged from the central float and the winch is collected inside the wind turbine tower.

The invention also provides a method of uninstalling the anchoring system comprising the following steps:
the winch is removed from the inside of the wind turbine tower, the winch is hooked to the central float, the central float is filled with water and the central float is lowered until all the first anchoring lines and the second anchoring lines are relaxed,
separation of the second anchoring lines from the inner end portions containing the inner free ends of the inner sections of the swinging arms,
the central float is raised with the winch to near the floating platform and the central float is emptied, with the second anchoring lines hanging from the bottom of the central float,
the central float is disengaged from the winch, which is collected inside the wind turbine tower through a hole passing through the center of the floating platform,
the corresponding ends of the first anchoring lines are separated from the floating platform, and each of these free ends of the first anchoring lines are joined with a respective buoy,
the floating platform is removed with the wind turbine tower that was located on the sea surface,
at least one anchoring block is removed from the seabed with its swinging arms 4, raising it towards the sea surface, with the first anchoring lines 11 hanging from the corresponding buoys 15, and loaded onto a barge,
the second anchoring lines of the central float are separated, holding them on the roof of the central float,
separation of the free end of the first anchoring lines of their respective buoy, and separation of the first anchoring lines from the outer end part containing the outer free end of the outer sections of the swinging arms, and
separation of at least one anchoring block from the swinging arms.

Through this configuration, an anchoring system is achieved that allows minimizing the pitch of the platform, since the second anchoring lines move synchronized by the movement of the central float, which makes the first anchoring lines also move in unison.

Likewise, the swinging arms eliminate the need for pulleys, thus avoiding the problem of bending fatigue of the ropes in the pulleys.

The described system therefore allows to use cables of much lower section than the anchoring cables used in the TLP platforms, and eliminates the risk of breakage of the cables due to the bending fatigue in the pulleys.

Other advantageous embodiments of the invention are outlined in the following description.

### BRIEF DESCRIPTION OF THE DRAWINGS

A non-limiting example of the object of the invention is shown below, with reference to the accompanying drawings wherein:

FIG. 1a shows a perspective view of an embodiment of the anchoring system of the invention.

FIG. 1b shows an enlarged detail of FIG. 1a.

FIG. 1c shows a plan view of the detail of FIG. 1b.

FIG. 2a shows a perspective view of another embodiment of the anchoring system of the invention.

FIG. 2b shows an enlarged detail of FIG. 2a.

FIG. 2c shows a plan view of the detail of FIG. 2b.

FIG. 3a shows a perspective view of another embodiment of the anchoring system of the invention.

FIG. 3b shows an enlarged detail of FIG. 2a.

FIG. 4a shows a perspective view of another embodiment of the anchoring system of the invention.

FIG. 4b shows an enlarged detail of FIG. 4a.

FIG. 5a shows a perspective view of another embodiment of the anchoring system of the invention.

FIG. 5b shows an enlarged detail of FIG. 5a.

FIG. 6 shows a schematic view of an anchoring system of the invention, in which the swinging arms have their outer section of the same length as their inner section.

FIG. 7 shows a schematic view of an anchoring system of the invention, in which the swinging arms have their outer section longer than their inner section.

FIG. 8 shows a schematic view of an anchoring system of the invention, in which the swinging arms have their outer section and their inner section inclined upwards.

FIG. 9 shows a schematic view of the anchoring system of the invention of FIG. 8, in which the floating platform has moved upwards.

FIG. 10 shows a schematic view of the anchoring system of the invention of FIG. 8, in which the floating platform has moved downwards.

FIG. 11 shows a schematic view of the anchoring system of the invention of FIG. 8, in which the floating platform has moved laterally.

FIG. 12 shows several elements of the anchoring system, before its installation.

FIG. 13 shows the transfer of the elements of FIG. 12 on the deck of a barge.

FIG. 14 shows the transfer of the floating platform from the anchoring system to the wind farm.

FIG. 15 shows the connection of the first anchoring lines with the outer sections of the swinging arms.

FIG. 16 shows the connection of the central float with the winch that is inside the wind farm tower.

FIG. 17 shows the stage in which the central float is flooded and descends until it approaches the swinging arms.

FIG. 18 shows the anchoring system of the invention once the installation procedure has been completed.

### DETAILED DESCRIPTION OF THE INVENTION

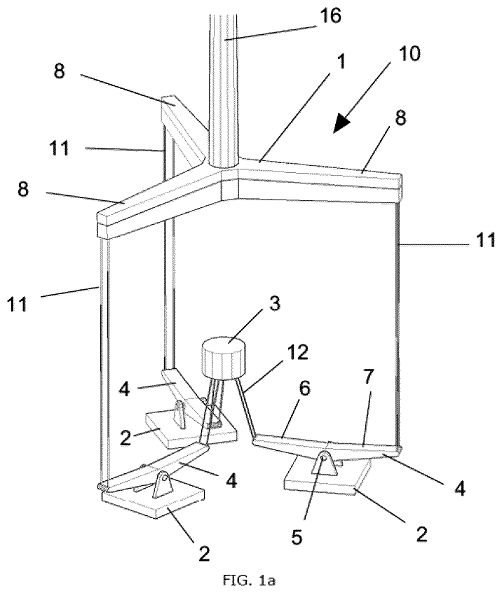

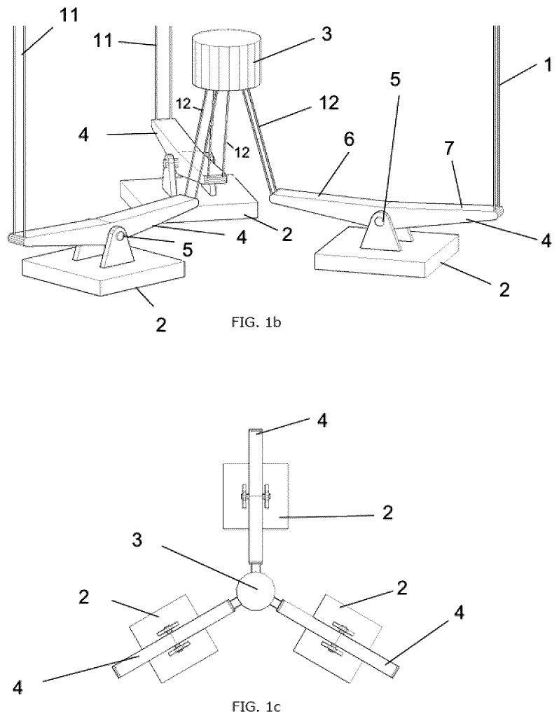

FIGS. 1a, 1b and 1c show an embodiment of an anchoring system 10 of the invention in operation, comprising the following elements:
a floating platform 1 from which a plurality of first anchoring lines 11 emerge,
several anchoring blocks 2, each with at least three non-aligned anchoring points,
a central float 3,
a plurality of swinging arms 4, so that each swinging arm 4 is joined by an articulated joint 5 to an anchoring block 2; said articulated joint 5 is located in an intermediate zone of the swinging arm 4 so that each swinging arm 4 comprises an internal section 6 and an external section 7 joined in the intermediate zone of the swinging arm 4 corresponding to the articulated joint 5; the internal section 6 is located between the intermediate zone of the swinging arm 4 and an internal free end, and the external section 7 is located between the intermediate zone of the swinging arm 4 and an external free end; the internal free end is closer to the central float 3 than the external free end, so that the first anchoring lines 11 that leave the floating platform 1 are joined to the external end that contains the external free end of the external sections 7 of the swinging arms 4; and
second anchoring lines 12 between the central float 3 and the inner end portions containing the inner free ends of the inner sections 6 of the swinging arms 4.

The floating platform 1 supports the wind turbine tower 16, which is part of a wind farm.

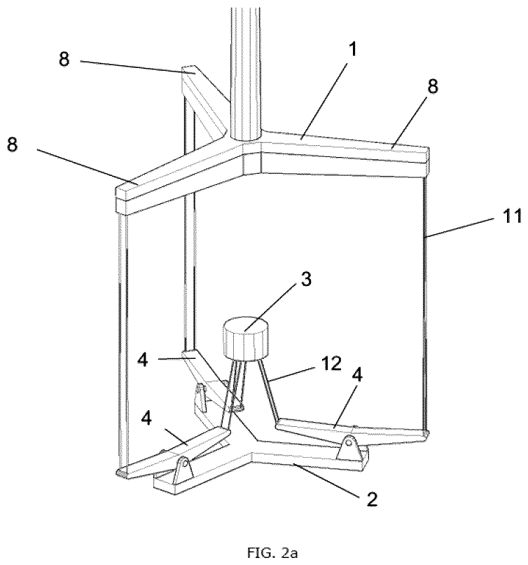

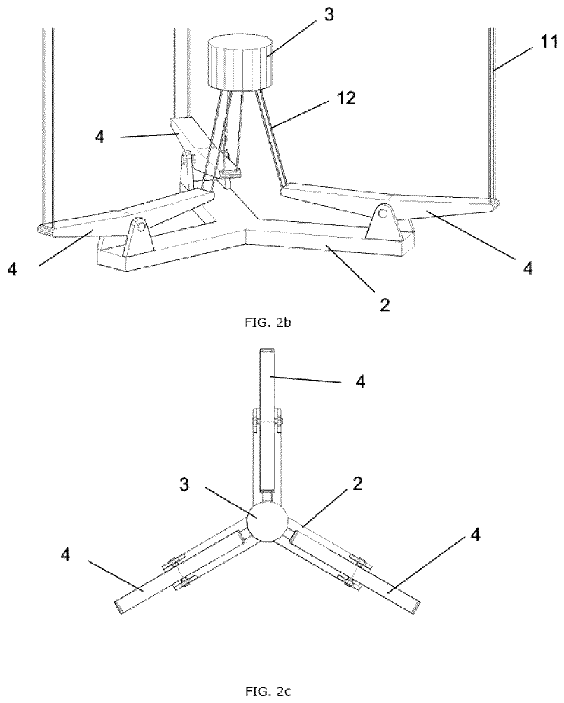

Likewise, each articulated joint 5 can be mounted on a support that is located on an anchoring block 2 (FIG. 2b allows to better observe these supports).

The anchoring system of these FIGS. 1a, 1b and 1c has three independent anchoring blocks (2) to which the corresponding swinging arms (4) are attached.

FIGS. 2a, 2b and 2c show another embodiment of an anchoring system of the invention in operation. This anchoring system has basically the same elements as the previous embodiment, but with a single anchoring block 2 to which the three swinging arms 4 are attached.

The anchoring blocks 2 have at least three non-aligned anchoring points, arranged in the shape of a triangle.

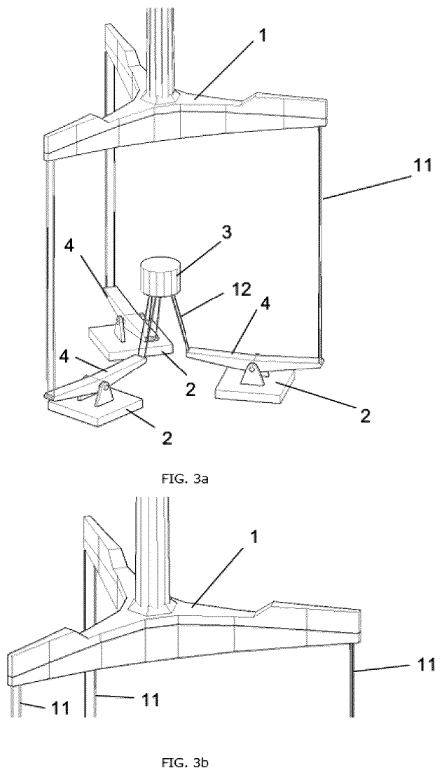

FIGS. 3a and 3b show an embodiment of an anchoring system of the invention, in which the floating platform 1 is star-shaped with a plurality of extension arms 8 (three extension arms, in this embodiment) radially arranged from the center of the floating platform 1 to an outer free end of each extension arm 8. From each of the three extension arms 8 of the floating platform 1 there are first anchoring lines 11, which are joined to three swinging arms 4, which are also in a radial arrangement.

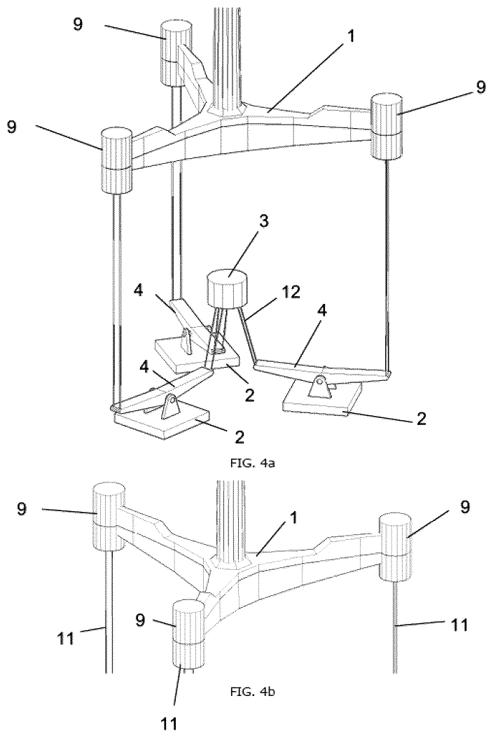

FIGS. 4a and 4b show another embodiment of an anchoring system of the invention, in which floats 9 are arranged at the free ends of the extension arms 8 of the floating platform 1. These floats can be slender and of vertical axis, and can protrude from the cover and the bottom of the extension arms 8, which improves the hydrodynamic behavior of the anchoring system when there are very large waves.

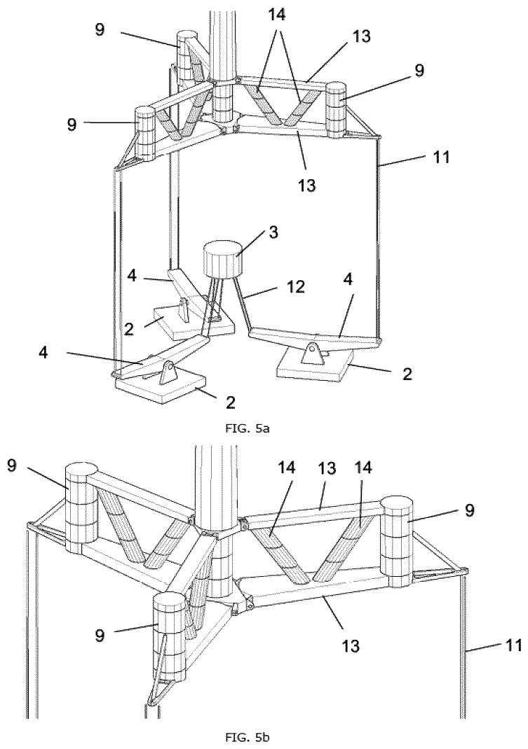

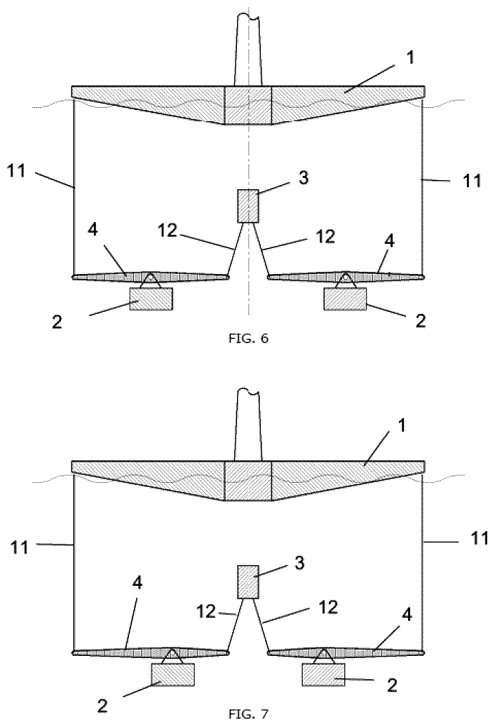

FIGS. 5a and 5b show another embodiment of an anchoring system of the invention, in which the extension arms consist of lattices with horizontal bars 13 and inclined bars 14, and with floats 9 at the free ends of the extension arms 8. This embodiment is more complex and expensive, but improves the hydrodynamics of the anchoring system.

FIG. 6 represents an embodiment of an anchoring system of the invention, in which the internal section 6 of each swinging arm 4 has the same length as the corresponding external section 7 of the corresponding swinging arm 4.

FIG. 7 represents an embodiment of an anchoring system of the invention, in which the internal section 6 of each swinging arm 4 has a length less than the corresponding external section 7 of the corresponding swinging arm 4.

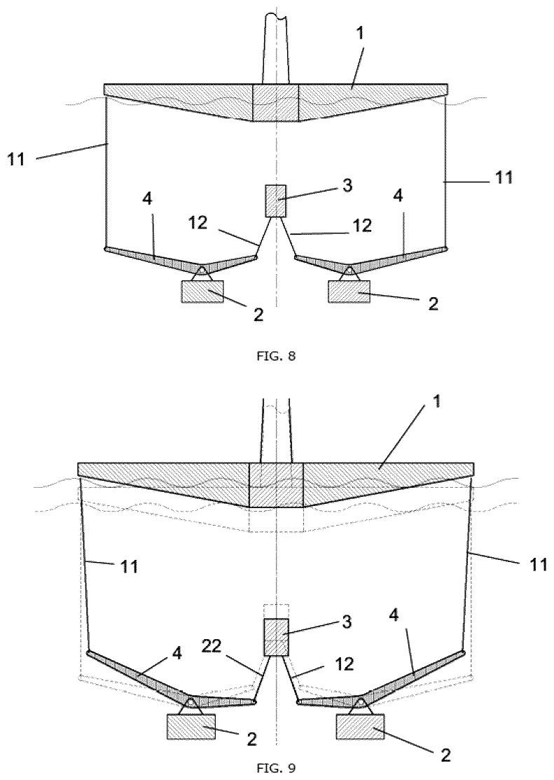

FIG. 8 represents an embodiment of an anchoring system of the invention, in which the inner section 6 and the outer section 7 of each swinging arm 4 are not aligned. In the specific embodiment of said figure, the internal sections 6 and the external sections 7 of the swinging arms 4 have an upward inclination from the articulated joint 5, forming an angle of less than 180°between them. In this way the swinging arms 4 do not hit the seabed when turning.

FIGS. 9, 10 and 11 show different possibilities of movement of the floating platform 1 and, therefore, of the anchoring system 10 of the invention.

In FIG. 9 the floating platform 1 moves upwards, which causes the first anchoring lines 11 to pull upwards the external sections 7 of the swinging arms 4, which rotate around the articulated joint 5, whereupon the internal sections 6 lower and the second anchoring lines 12 pull downwards the central float 3.

In FIG. 10 the floating platform 1 moves downwards, which causes the first anchoring lines 11 to pull down the external sections 7 of the swinging arms 4, which rotate around the articulated joint 5, with which the internal sections 6 rise and the second anchoring lines 12 and the central float 3 also rise.

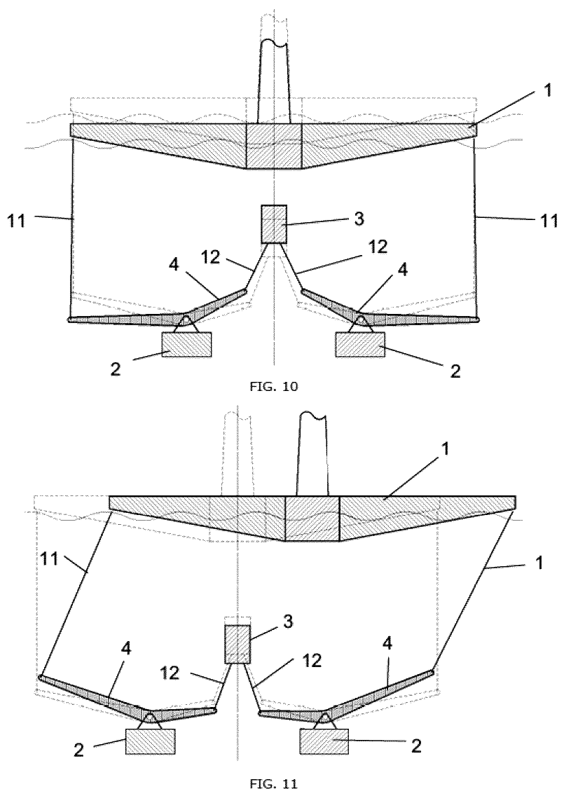

In FIG. 11 the floating platform 1 moves laterally. This movement rotates the swinging arms 4 around the articulated joint 5, which produces the movement of the central float 3.

In FIGS. 9, 10 and 11 it is observed that the horizontal movement of the central float 3 practically disappears, while the vertical movement of the central float 3 becomes small.

The fact that the central float 3 has a reduced movement has beneficial effects on the mechanical wear of the elements that make up the anchoring system, and makes the central float 3 subject to small accelerations. In particular, vertical acceleration makes the float less effective, since part of the vertical thrust (which is what tensions the anchoring lines) is lost in compensating the inertial forces of the central float 3 itself. The lower the acceleration, the greater the effective stress in the anchoring lines and the more efficient the anchoring system when maintaining the right platform without inclination.

In the anchoring system of the invention, the movement of the central float 3 is half that of the platform. If the vertical accelerations of the floating platform 1 in waves becomes 3 m/s2, the vertical accelerations of the central float 3 are reduced to 1.5 m/s2, i.e. it maintains much of its effectiveness even with the worst waves.

In the embodiment shown, for example, in FIGS. 3a and 3b, the floating platform 1 is star-shaped with three extension arms 8 in radial arrangement, three first anchoring lines 11 and three swinging arms 4. However, it is also possible to make anchoring systems with four extension arms 8 on the floating platform 1 from which there are four first anchoring lines 11 attached to four swinging arms 4 in a radial arrangement, or with five extension arms 8 on the floating platform 1 from which there are five first anchoring lines 11 attached to five swinging arms 4 in a radial arrangement (not shown in the figures). These anchoring systems are more complex and difficult to install, but they also provide more security.

Likewise, the first anchoring lines 11 and the second anchoring lines 12 may be anchoring chains or cables.

The installation procedure of the anchoring system of the invention comprises the steps described below.

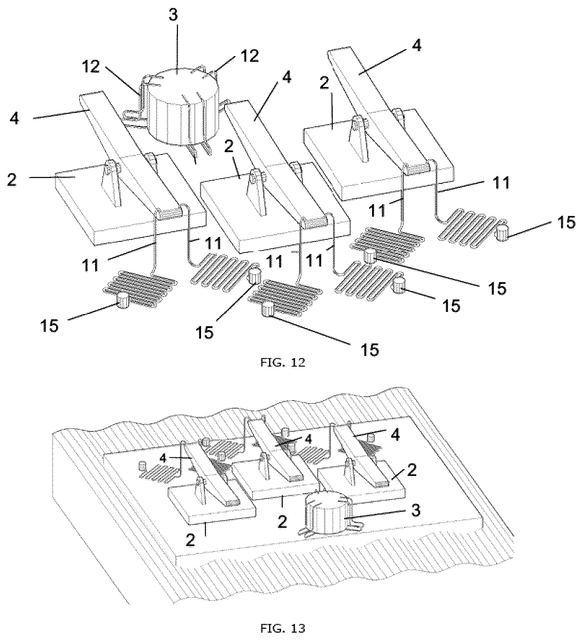

The anchoring blocks 2 are manufactured and the anchoring blocks 2 are assembled on the ground with the swinging arms 4, each swinging arm 4 being joined by means of an articulated joint 5 with a support to an anchoring block 2. Also included are the first anchoring lines 11 that will go to the floating platform 1 with a buoy 15 at the tip, whose buoyancy is able to support the full weight of the first anchoring lines 11 (FIG. 12).

The central float 3 is built and the second anchoring lines 12 that will connect with the inner end of the swinging arms 4 of the anchoring blocks 2 are hooked, the second anchoring lines 12 are stowed (properly placed and fastened so that they do not move or fall during the trip) on the roof of the central float 3. The central float 3 will travel to the wind farm empty of internal ballast, that is, with a great buoyancy (FIG. 13).

The anchor blocks 2 are loaded onto a barge and moved to the wind farm, to the position where the anchoring system is to be installed. There they are lifted with a crane (from the same barge or from an auxiliary vessel) and lowered to the seabed, to place them in their proper position, and with the swinging arms 4 radially oriented. The first anchoring lines 11 that will be connected to the floating platform 1 are vertical and reach the sea surface, hanging from the corresponding buoy 15 (the first anchoring lines 11 are a little longer than the sea depth at the point of installation).

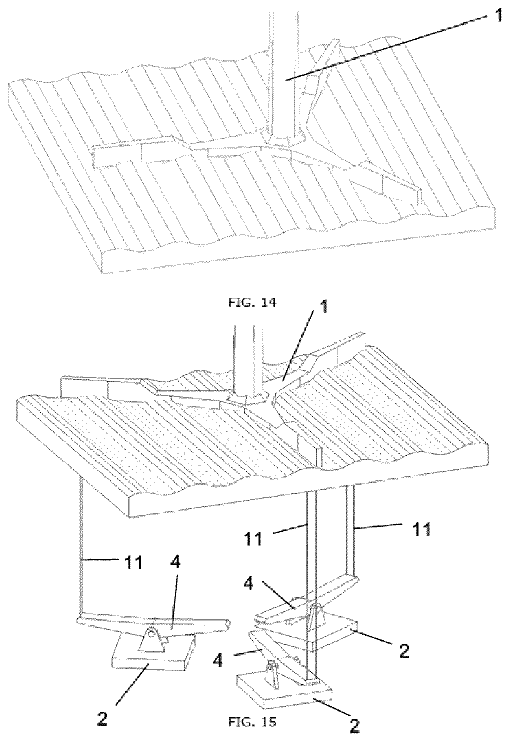

Floating platform 1 (floating by itself) is moved to the wind farm (FIG. 14).

The first anchoring lines 11 are connected to fixed points of the floating platform 1 and the buoyancy buoys 15 are eliminated (they are auxiliary installation elements) (FIG. 15).

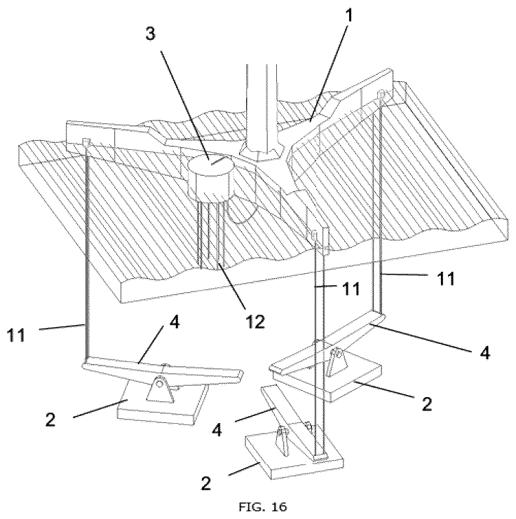

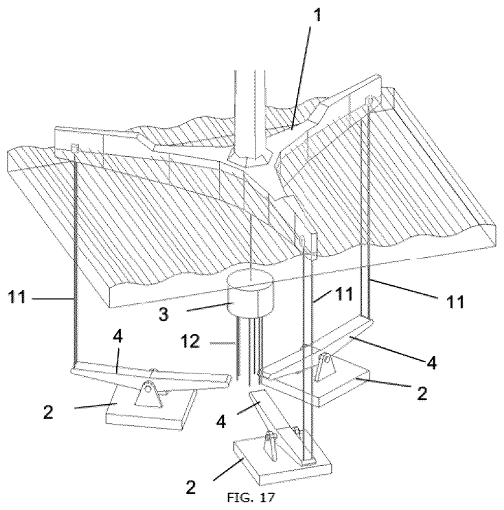

The central float 3 is placed near the floating platform 1 and is hung from a strand jack winch (it is a special type of hydraulic jack that drags lifting cables) that is inside the tower 16 of the wind turbine, whose cables pass through a hole in the center of the floating platform 1 (FIG. 16).

The central float 3 (left hanging from the winch) is flooded, with the second anchoring lines 12 hanging from the bottom of the central float 3 and lowered to near the seabed (until the free end of the second anchoring lines 12 is near the swinging arms 4 of the anchor blocks 2 (FIG. 17).

The second anchoring lines 12 are connected to the inner end portions containing the inner free ends of the inner sections 6 of the swinging arms 4 of the anchoring blocks 2. This can be done with the help of an ROV (remotely operated vehicle, that is, an underwater robot).

The central float 3 is emptied of ballast (with compressed air or with ballast pumps that discharge the interior water, to the surface of the sea) until it is completely empty, providing all the buoyancy that this element needs.

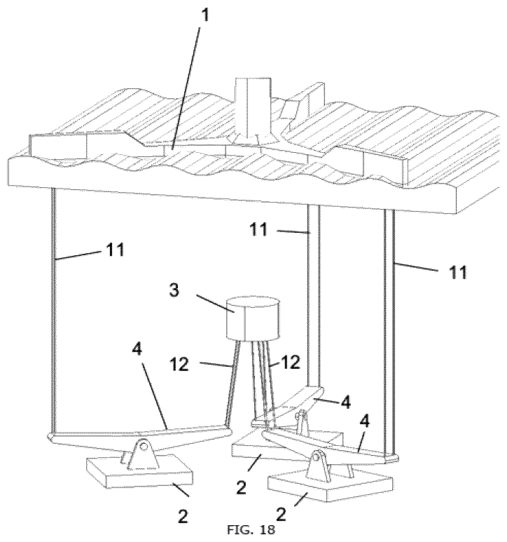

The winch cable is unhooked and collected inside the wind turbine tower 16. This cable will be used again when the central float 3 has to be disconnected (for some repair, or to disassemble the anchoring system) (FIG. 18).

The umbilical cable (the one connecting the generator to the ground mains) is connected, so that the wind turbine is ready to generate energy.

The procedure for uninstalling the anchoring system 10 has the same steps as the procedure for installing the anchoring system 10, but with the time sequence reversed.

In particular, these would be the steps of the uninstallation procedure of the anchoring system 10 of the invention:
the winch is removed from inside the tower 16 of the wind turbine, the winch is hooked to the central float 3, the central float 3 is filled with water and the central float 3 is lowered until all its buoyancy is lost, so that all the first anchoring lines 11 and the second anchoring lines 12 are relaxed,
separation of the second anchoring lines 12 from the inner end portions containing the inner free ends of the inner sections 6 of the swinging arms 4,
the central float 3 is raised with the winch to near the floating platform 1 and the central float 3 is emptied, with the second anchoring lines 12 hanging from the bottom of the central float 3,
the central float 3 (which now floats by itself) is disengaged from the winch, which is collected inside the tower 16 of the wind turbine through a hole that passes through the center of the floating platform 1,
the corresponding ends of the first anchoring lines 11 are separated from the floating platform 1, and each of these free ends of the first anchoring lines 11 is joined with a respective buoy 15,
the floating platform 1 is removed with the wind turbine tower 16 that was located on the sea surface,
at least one anchoring block 2 is removed from the seabed with its swinging arms 4, raising it towards the sea surface, with the first anchoring lines 11 hanging from the corresponding buoys 15, and loaded onto a barge,
the second anchoring lines 12 of the central float 3 are separated, holding them on the roof of the central float 3,
separation of the free end of the first anchoring lines 11 from their respective buoy 15, and separation of the first anchoring lines 11 from the outer end part containing the outer free end of the outer sections 7 of the swinging arms 4, and
separation of at least one anchoring block 2 from the swinging arms 4.

Although some embodiments of the invention have been described and represented, it is clear that modifications may be introduced to them within the scope of the same, and that the invention should not be considered limited to these embodiments, but only to the content of the following claims.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1.-16. (canceled)

17. An anchoring system, wherein the anchoring system comprises:
a floating platform from which a plurality of first anchoring lines emerge,
at least one anchoring block with at least three non-aligned anchoring points,
a central float,
a plurality of swinging arms, each swinging arm being joined by an articulated joint to an anchoring block, said articulated joint located in an intermediate area of the respective swinging arm so that each swinging arm comprises an internal section and an external section joined in the intermediate area of the swinging arm corresponding to the articulated joint, the internal section located between the intermediate area of the swinging arm and an inner free end and the external section located between the intermediate area of the swinging arm and an outer free end, the inner free end closer to the central float than the outer free end, so that the first anchoring lines of the plurality of first anchoring lines emerging from the floating platform are joined to the outer free ends of the swinging arms, and
second anchoring lines between the central float and the inner free ends of the swinging arms.

18. The anchoring system according to claim 17, wherein the internal section of each swinging arm has a length that is the same as a length of a corresponding external section of the respective swinging arm.

19. The anchoring system according to claim 17, wherein the internal section of each swinging arm has a length less than a length of a corresponding external section of the respective swinging arm.

20. The anchoring system according to claim 17, wherein the internal section and the external section of each swinging arm are not aligned.

21. The anchoring system according to claim 17, wherein the floating platform is star-shaped and has a center, and
wherein the floating platform comprises a plurality of extension arms radially arranged from the center of the floating platform to an outer free end of each extension arm.

22. The anchoring system according to claim 17, wherein the floating platform comprises three extension arms from which three first anchoring lines emerge, joined to three swinging arms in a radial arrangement.

23. The anchoring system according to claim 17, wherein the floating platform comprises four extension arms from which four first anchoring lines emerge, joined to four swinging arms in a radial arrangement.

24. The anchoring system according to claim 17, wherein the four extension arms each comprises lattices with horizontal bars and inclined bars.

25. The anchoring system according to claim 17, wherein the floating platform comprises five extension arms from which five first anchoring lines emerge, joined to the five swinging arms in a radial arrangement.

26. The anchoring system according to claim 17, further comprising floats at the free ends of the extension arms of the floating platform.

27. The anchoring system according to claim 17, wherein only a single anchoring block is provided, and
wherein the swinging arms are attached at a plurality of non-aligned points to the single anchoring block.

28. The anchoring system according to claim 17, further comprising at least three anchoring blocks to which the corresponding swinging arms are attached.

29. The anchoring system according to claim 17, wherein the first anchoring lines and the second anchoring lines are anchoring chains or cables.

30. The anchoring system according to claim 17, wherein the connection of each swinging arm with an anchoring block is made by an articulated connection with a support.

31. A method for installing an anchoring system, the method comprising the following steps:
assembling at least one anchoring block with a plurality of swinging arms, each swinging arm being joined by an articulated joint with a support to the at least one anchoring block;
fixing first anchoring lines to outer free ends of the swinging arms;
joining free ends of the first anchoring lines to respective buoys;
fixing second anchoring lines to a central float;
placing the at least one anchoring block on a seabed, so that the first anchoring lines are deployed vertically hanging from the corresponding buoys,
locating the floating platform with a wind turbine tower on a sea surface, vertically with respect to a position of the at least one anchoring block,
releasing the buoys from the free ends of the first anchoring lines and joining said free ends of the first anchoring lines to the floating platform;
placing the central float next to the floating platform and hooking the central float to a winch inside the wind turbine tower having cables passing through a hole that passes through a center of the floating platform;
flooding the central float, so that that the central float descends and hangs from the winch with the second anchoring lines hanging from a bottom of the central float;
joining the second anchoring lines with inner free ends of the swinging arms;
emptying the central float and disengaging the winch from the central float and collecting the winch inside the wind turbine tower.

32. A method for uninstalling an anchoring system, the method comprising the following steps:
removing a winch from inside of a wind turbine tower of a floating platform, the winch hooked to a central float;
filling the central float with water and lowering the central float until first anchoring lines and second anchoring lines are relaxed;
separating the second anchoring lines from inner free ends of swinging arms joined to an anchoring block;
raising the central float with the winch towards the floating platform and the emptying the central float, so that the central flow rises towards the floating platform with the second anchoring lines hanging from a bottom of the central float,
disengaging the central float from the winch and collecting the winch inside the wind turbine tower through a hole that passes through a center of the floating platform;
separating ends of the first anchoring lines with respect to the floating platform and joining each end of the first anchoring lines with a respective buoy;
removing the floating platform with the wind turbine tower that was located on a marine surface;
removing the anchoring block with the swinging arms from a seabed, raising the anchoring block towards a sea surface, with the first anchoring lines hanging from the corresponding buoys, and loading the anchoring block on a barge;
separating the second anchoring lines of the central float and holding the second anchoring lines on a roof of the central float;
separating the ends of the first anchoring lines from the respective buoy and separation of the first anchoring lines from outer free ends of the swinging arms; and
separating the at least one anchoring block from the swinging arms.
